(19) United States
(12) Patent Application Publication
(10) Pub. No.: US 2019/0274317 A1
(43) Pub. Date: Sep. 12, 2019

(54) Cutting device for soft-cut foods

(71) Applicant: LYNDA GRAUBERT, NEW YORK, NY (US)

(72) Inventor: LYNDA GRAUBERT, NEW YORK, NY (US)

(73) Assignee: LYNDA GRAUBERT, NEW YORK, NY (US)

(21) Appl. No.: 15/932,508

(22) Filed: Mar. 8, 2018

(51) Int. Cl. A21C 15/04

(52) U.S. Cl. CPC A21C 15/04; B26B 29/063

(57) ABSTRACT

A cutting device for soft-cut foods, includes a base member and a cutter member. The base member has a top, a bottom and at least one side with a predetermined shape as defined from a top view footprint, and has a plurality of blade-receiving grooves on its top and positioned to receive a corresponding set of soft-cut blades of a cutter member. It also has handles and at least one alignment component for alignment of the cutter member so as to position the blades in alignment and above the grooves. The cutter member has a frame, a plurality of groove-corresponding blades, handles and at least one alignment component corresponding to the base member at least one alignment component.

### REFERENCE TO RELATED APPLICATIONS

The present application is not related to any pending or issued United States of America or foreign patent or patent application.

### BACKGROUND OF INVENTION

### a. Field of Invention

The present invention generally relates to cutting foods into predetermined patterns in such a way as to accomplish four objectives: first, achieve a clean cut by use of a base with blade-receiving grooves; second, use alignment guidance so that the cutting blades are positioned to end up in those grooves; third, provide a device that may remain in place with the food after cutting it, for subsequent presentation, serving and storage; and, fourth provide consistent, repeat cuttings. Previously designed and current soft-cut food cutters do not achieve all of these objectives.

### b. Description of Related Art

The following patents are representative of the field pertaining to the present invention:

U.S. Pat. No. 4,195,402 to Leffer describes a dessert cutter particularly useful for delicate cakes with soft and moist composition. A frame supports a plurality of taut wires in a geometric relationship. The frame provides a grip for pressing the wires through a cake and a guide surface for visual alignment during the cutting application.

U.S. Design Pat. No. 298,603 to White describes a cutting tool for baked goods showing crisscrossed blades in a square pattern.

U.S. Design Pat. No. 358,969 to Romanoff shows a pizza cutter for a rectangular pizza with cutting blades arranged in triangles.

U.S. Design Pat. No. 718,096 to Smith shows a circular cake cutter with symmetrically arranged wire blades.

Notwithstanding the prior art, the present invention is neither taught nor rendered obvious thereby.

### SUMMARY OF INVENTION

The present invention is directed to cutting devices that provide for efficient clean cuts of soft-cut foods by employing two separate members—a base member with blade-receiving grooves and a cutting member with blades for cutting through the food and nesting in the grooves. Additionally, these present invention devices may remain in place with the food after it has been cut, for presenting, serving and storing the food. The term “soft-cut foods” as used herein broadly means foods that may be cut with a dull blade and without significant cutting force. Examples are pizzas, cakes, brownies, pies, pancakes, but especially to include baked goods. By “blades” as used herein means thin knife units typically in the form of vertically elongated pieces (vertical sheets), having a bottom edge as thin as desired and as thick as possible to still afford good cutting. As a practical matter, a beneficial range would be no more than ⅛ inch and preferably thinner, such as equal or less than 1/16 inch. Alternatively, the blades may be horizontal rods or wires, e.g., within a range of ⅛ inch down to very thin wires or rods.

Thus, the present invention is a cutting device for soft-cut foods, which includes: a) a base member, the base member having a top, a bottom and at least one side, and having a predetermined shape as defined from a top view footprint, and having a plurality of blade-receiving grooves on its top and positioned to receive a corresponding set of soft-cut blades of a cutter member, the base member having at least one alignment component for alignment of the cutter member so s to position the blades in alignment and above the grooves; and b) the cutter member, having a frame with view footprint shape corresponding to the base member, the frame having an open inside from the top view, and having a plurality of soft-cut blades located at the inside of the frame and corresponding to the plurality of blade receiving grooves, the cutter member having at least one alignment component corresponding to the base member at least one alignment component. A user may place a soft-cut food on the base member, place the cutter member above the soft-cut food and base member, align the at least one base member alignment component and the at least one cutter member alignment component, and then press down so as to cut the food and so as to pass through the food, such that the plurality of blades nests in the plurality of blade receiving grooves for a complete soft cut.

In some embodiments of the present invention cutting device, the predetermined shape is selected from the group consisting of circular, square, rectangular, polygonal and oval.

In some embodiments of the present invention cutting device, the cutter member has two opposing handles. These handles will preferably protrude outwardly on opposing sides of the cutter member and may be flat or tilted and may be open or closed. There main function is for pressing the cutter member down through the food to be cut and into the grooves of the base member.

As a practical matter, a user cannot see through a cake or other food product once it is placed on the base member for cutting. Therefore, there should be some way of aligning the blades of the cutter member with the groves of the base member is necessary. Guides that protrude are the simplest means for accomplishing blade/groove alignment. These guides are generally referred to herein as alignment components. In some embodiments of the present invention, two opposing handles also perform as and thus are alignment components. In other embodiments, the alignment components are separate from the handles, e.g., protruding eyelets. Therefore, in some embodiments, the cutter member has two opposing handles and the (at least one) alignment component(s) of the cutter member is separate from the two opposing handles.

In addition, the base member may have handles and these may also be the alignment component(s) or the base member handles may be separate from one or more base member alignment components. Thus, in some embodiments, the base member has two opposing handles and the at least one alignment component of the base member is separate from the two opposing handles.

In some embodiments of the present invention cutting device, both the cutter member and the base member have opposing handles and the cutter member handles are shorter than the base member handles such that all handles function also as alignment components.

In some embodiments of the present invention, the grooves of the base member are symmetrically positioned relative to one another, and the blades of the cutter member are correspondingly symmetrically positioned.

In some embodiments the blades are blades are comprised of materials selected from the group consisting of metal, plastic, natural material and combinations thereof. In some embodiments, the blades are selected from the group consisting of flat blades, round blades and wire blades. Wire blades may be single strand and plural strand wires that may be straight or twisted or woven.

In some embodiments of the present invention cutting device, the cutting member frame is selected from the group consisting of metal, plastic, natural material, and combinations thereof.

In some embodiments of the present invention cutting device, all of the members and components of the device are metal. In some embodiments of the present invention cutting device, the all of the members and components of the device are non-stick coated metal.

In some embodiments of the present invention cutting device, all of the members and components of the device are metal selected from the group consisting of aluminum and stainless steel.

In some embodiments of the present invention cutting device, all of the members and components of the device are plastic members and components.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS(S)

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an oblique top view of one embodiment of a present invention cutting device for soft-cut foods, showing an exploded view of the cutter member, the base member and a cake there between and positioned for cutting;

FIGS. 2 and 3, respectively, show top views of another embodiment of a present invention cutting device cutter member and corresponding/receiving base member, with separate handles and alignment components;

FIG. 4 shows a top view of another alternative embodiment cutting device cutter member, and FIG. 5 illustrates a partial side cut view thereof, wherein the handles also include eyelets and thus function both as handles and as alignment components (eyelet alignment guides);

FIGS. 6 and 7, respectively, show top views of another embodiment of a present invention cutting device cutter member and corresponding/receiving base member, wherein the base member has an upwardly projecting short rods on the handles for receiving corresponding orifices on the cutting member handles for accurate alignment to direct and allow the cutting blades to fit into the receiving grooves; and,

FIGS. 8 and 9 show partial cut side views of the present invention cutting device shown in FIGS. 6 and 7, above, illustrating how the short rods of the base member work in conjunction with the orifices of the cutter member to mesh with one another and to thereby align the cutting blades with the receiving grooves.

### DETAILED DESCRIPTION OF THE EMBODIMENTS

The present invention involves a cutting device for soft-cut foods that includes a cutter (top) member and a base (bottom) member with blades and receiving grooves, respectfully.

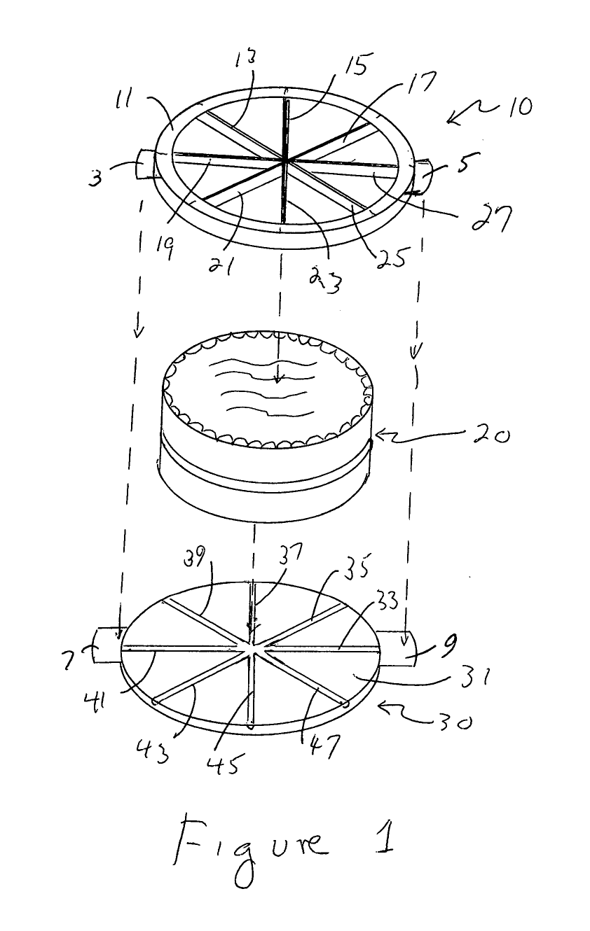

FIG. 1 shows an oblique top view of one embodiment of a present invention cutting device for soft-cut foods, such as double layer cake 20. This is an exploded view of the cutter member 10, the base member 30 and the cake 20. Cutter member 10 is circular from a top view (has a round top view footprint) and thus has a circular frame 11 with a plurality of evenly spaced blades 11, 13, 15, 17, 19, 21, 23, 25 and 27. These blades are symmetrically arranged so as to yield eight pieces of cake when applied to cut cake 20 or any other soft-cut food. Two opposing handles 3 and 5 are used to both align the blades with the corresponding grooves and to push down on the cutter member 10 to cut through cake 20. Base member 30 is a solid plate 31 with a top, side and bottom, handles 7 and 9 and has deep cut grooves 33, 35, 37, 39, 41, 43, 45 and 47 in its top. Although this is an exploded view to show more detail, in reality, the cake is placed on base member 30 and cutter member 10 is pressed down upon the cake 20. This is properly accomplished by first aligning cutter member handles 3 and 5 with base member handles 7 and 9. This is done visually by looking down from above. Note that the base member handles 7 and 9 are longer (protrude further away from the main structure) than handles 3 and 3 on the cutter member. These longer base handles afford two advantages: (1) because they protrude further out, they are easier to see and (2) thus help the use of the handles to align components so that the blades enter the grooves when pushing down until the cutter member stops. They function both as handles and alignment components. Alternative to solid handles would be open handles, and in cases where the handles function also as the alignment components, any alignment enhancements may be employed, such as handle shape differences between cutter member handles and base member handles, eyelets, markings, indents detents, crosshairs, and combinations. One example of combinations would be eyelets in the cutter member handles and a dot or star embossed on the base member handles.

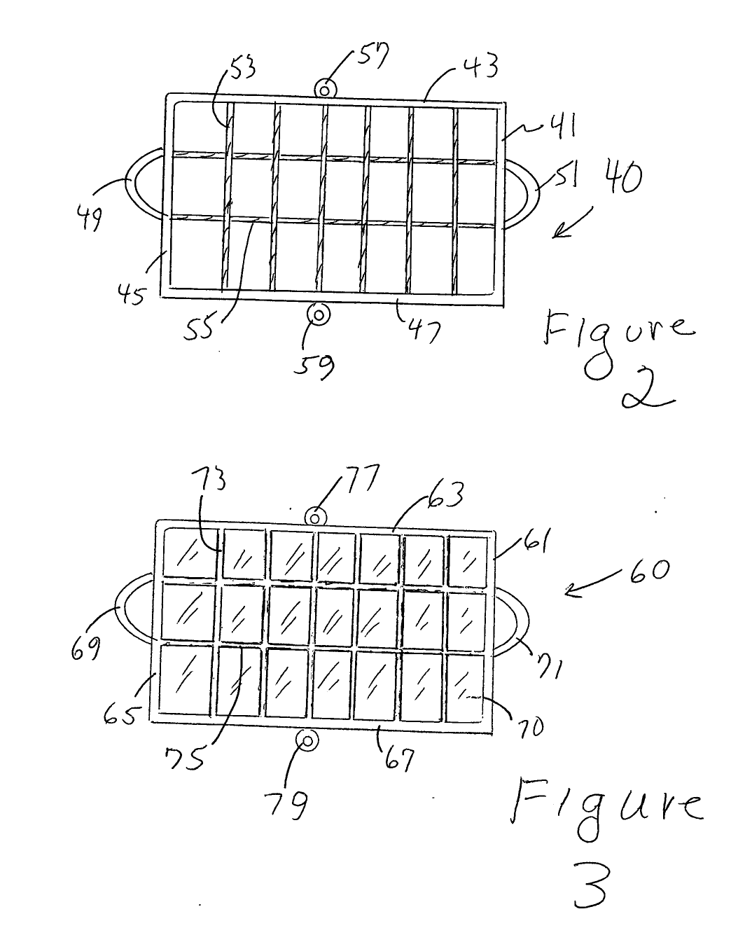

FIGS. 2 and 3, respectively, show top views of another embodiment of a present invention cutting device cutter member 40 and corresponding base member 50, each with separate handles and alignment components. Referring specifically to FIG. 2, there is shown a present invention cutting device cutter member 40, with a rectangular open frame comprise of four sides, namely, frame sides 41, 43, 45 and 47, establishing a rectangular shape for cutting rectangular cakes, brownies sheets, etc. it could likewise cut a soft-cut food of any shape, if it fit within the inside perimeter of the frame. Thus a square or oval or other shaped cake, if its dimensions were within the inside frame perimeter, could be cut with this cutter member 40 and its corresponding base member 60 of FIG. 3 described below. Cutter member 40 has a plurality of blades, such as blade 53 and blade 55, within and connected to the frame. It also has handles 49 and 51, as shown, and separate, opposing alignment eyelets 57 and 59. The blades may be dull or sharp and the structure may be metal, plastic or combinations thereof, or in combination with other materials, such as non-stick coating. An inexpensive version might be made of heavy duty plastic, whereas a luxury version may be may be of stainless steel or non-stick-coated aluminum, each with or without decorative features.

FIG. 3 shows the corresponding base member 60 with the same footprint and configuration, so that cutter member 40 of FIG. 2 meshes with it. Base member 60 includes a frame with four frame sides 61, 63, 65 and 67. It also a main base plate-like structure 70 and has handles 69 and 71 and blade receiving grooves, such as grooves 73 and 75. It further has corresponding eyelets 77 and 79 that will sit under and be eyelet guides for eyelets 57 and 59 of cutter member 40 (FIG. 2). A user will place the food to be cut on base member 60, align the cutter member 40 visually with the base member 60 by aligning the corresponding eyelets (eyelet 57 with eyelet 77 and eyelet 59 with eyelet 79, for example), and then pressing down until the blades cut through the food and enter the receiving grooves. Because the cutter member and the base member mesh and are low relative to the food, the food, such as a cut cake, may remain in the present invention cutting device for presentation/consumption, and even subsequent storage with easy access for consumption. Alternatively, the present invention device may be immediately removed from the cut food and used repeatedly to cut many different units of food to be cut.

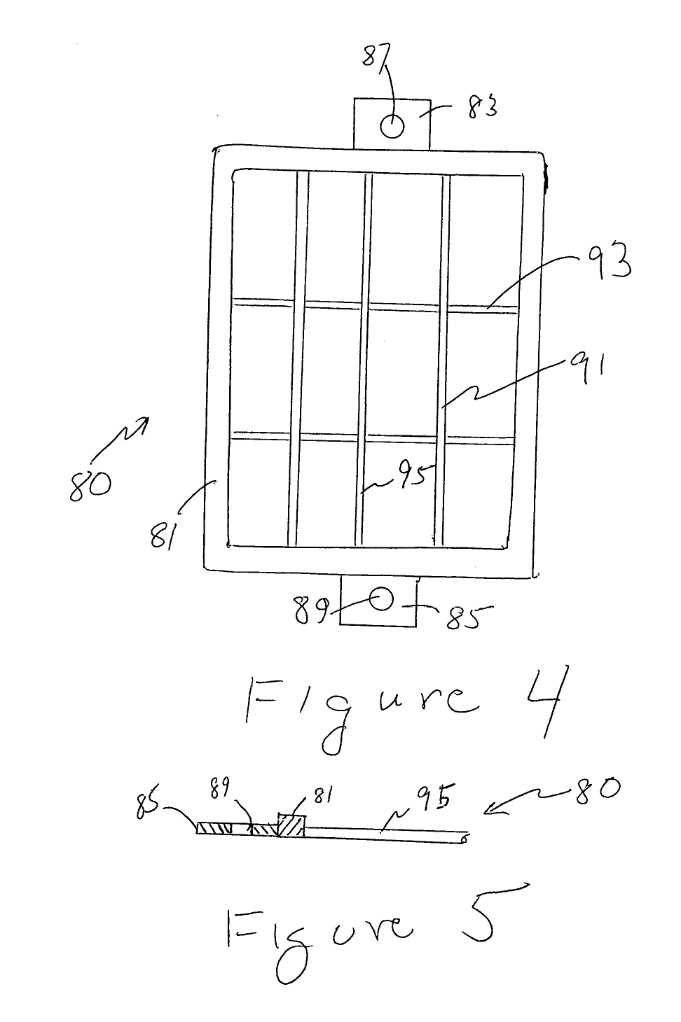

FIG. 4 shows a top view of another alternative embodiment cutting device cutter member 80, and FIG. 5 illustrates a partial side cut view thereof, wherein the handles 83 and 85 also include eyelets 87 and 89 and thus function both as handles and as alignment components (eyelet alignment guides). This top unit, cutter member 8, has a corresponding bottom unit (base member, not shown), and includes cutting blades, such as blades 91, 93 and 95, supported by frame 81. The base member not shown would have receiving grooves corresponding to the blades of cutter member 80 and would have handles in the same position as handles 83 and 85 so that when such a base member held at cake or other food and cutter member 80 was placed over it, a user may look through eyelets 87 and 89 to spot a corresponding mark or target on the base member handles, for proper alignment and cutting. FIG. 5 shows a side partial cut view so that the eyelet 89 may be more easily visualized. Otherwise, parts in FIG. 5 identical to those in FIG. 4 are identically numbered.

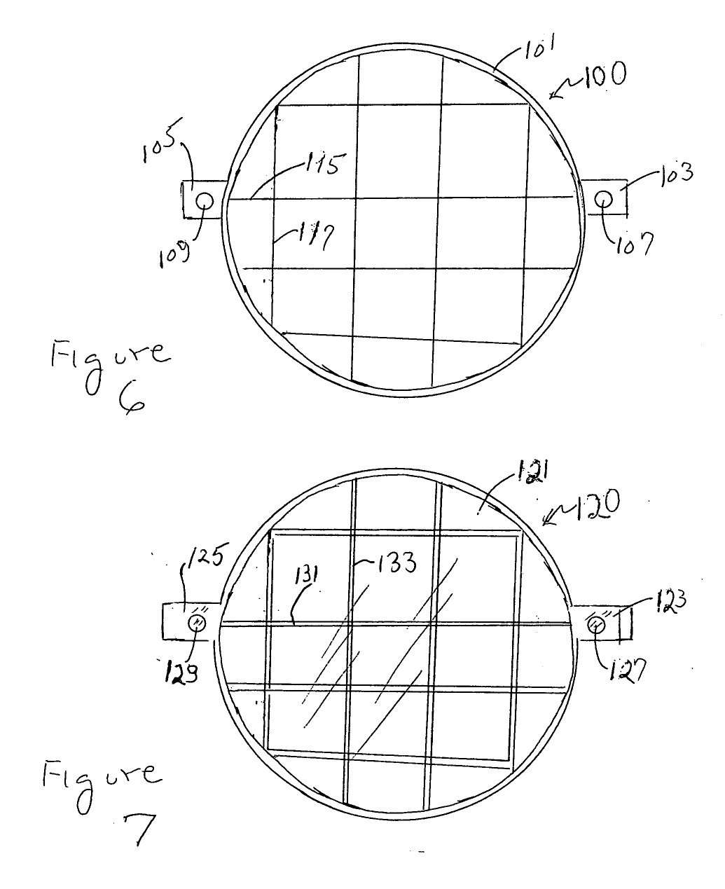

FIGS. 6 and 7, respectively, show top views of another embodiment of a present invention cutting device cutter member 100 and corresponding base member 120. In FIG. 6, the cutter member 100 has a main support frame 101 and blades, such as blades 115 and 117, and handles 103 and 105. The handles 103 and 105 have receiving orifices 107 and 109 respectively, that are alignment components and base-connecting components as well. In FIG. 7, base member 120 has a main support plate 121 with blade-receiving grooves, such as grooves 131 and 133. Base member 120 also has handles 123 and 125 with upwardly projecting short rods 127 and 129 (alignment components) on the handles 123 and 125 respectively for receiving corresponding orifices 107 and 109 on the cutting member handles 103 and 105 for accurate alignment to direct and allow the cutting blades to fit into the receiving grooves when completing a food cutting process.

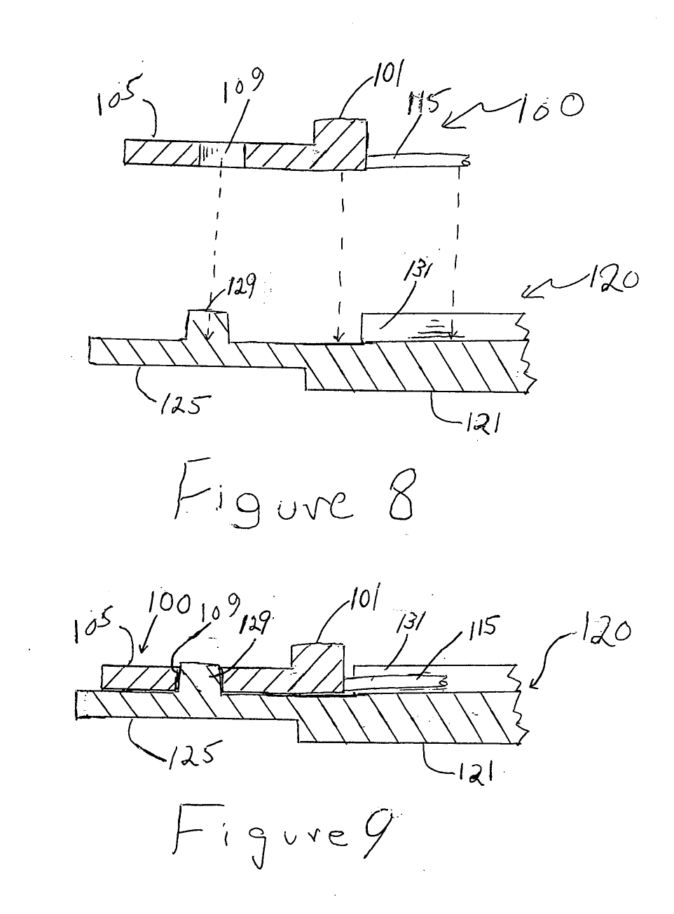

FIGS. 8 and 9 show partial cut side views of the present invention cutting device cutter member 100 and base member 120 shown in FIGS. 6 and 7, above, illustrating how the short rods 127 and 129, and specifically illustrating rod 129, of the base member 120 work in conjunction with the orifices 107 and 109, specifically showing orifice 109 of the cutter member 100 to mesh with one another and to thereby align the cutting blades with the receiving grooves. FIG. 8 shows a blown apart view and FIG. 9 shows a completed cut/nesting view thereof.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the actual shape of the main housing may be any of numerous possibilities as long as its functionality as described is not affected adversely. Likewise, the blades do not need to be in straight lines and could have curvilinear or other top view configurations without exceeding the scope of the present invention.

What is claimed is:

1. A cutting device for soft-cut foods, which comprises:
a) a base member, said base member having a top, a bottom and at least one side, and a predetermined shape, with a plurality of blade-receiving grooves on its top and positioned to receive a corresponding set of soft-cut blades of a cutter member. It also has at least one alignment component for alignment of said cutter member so as to position said blades in alignment and above said grooves;
b) said cutter member, having a frame with view footprint shape corresponding to said base member, said frame having an open inside from said top view, and having a plurality of soft-cut blades located at said inside of said frame and corresponding to said plurality of blade receiving grooves, said cutter member having at least one alignment component corresponding to said base member at least one alignment component;
wherein a user may place a soft-cut food on said base member, place said cutter member above said soft-cut food and base member, align said at least one base member alignment component and said at least one cutter member alignment component, and then press down so as to cut said food and so as to pass through said food, such that said plurality of blades nests in said plurality of blade receiving grooves for a complete soft cut.

2. The cutting device of claim 1 wherein said predetermined shape is selected from the group consisting of circular, square, rectangular, polygonal and oval.

3. The cutting device of claim 1 wherein said cutter member has two opposing handles.

4. The cutting device of claim 3 wherein said two opposing handles are also alignment components.

5. The cutting device of claim 4 wherein said base member has opposing handles and said opposing handles are also alignment components.

6. The cutting device of claim 1 wherein said cutter member has two opposing handles and said at least one alignment component of said cutter member is separate from said two opposing handles.

7. The cutting device of claim 1 wherein said base member has two opposing handles and said at least one alignment component of said base member is separate from said two opposing handles.

8. The cutting device of claim 1 wherein said grooves are symmetrically positioned relative to one another, and said blades are correspondingly symmetrically positioned.

9. The cutting device of claim 1 wherein said blades are blades comprising materials selected from the group consisting of metal, plastic, natural material and combinations thereof.

10. The cutting device of claim 9 wherein said blades are selected from the group consisting of flat blades, round blades and twisted wire blades.

11. The cutting device of claim 1 wherein said cutting member frame is selected from the group consisting of metal, plastic, natural material, and combinations thereof.

12. The cutting device of claim 1 wherein both said cutter member and said base member have opposing handles and said cutter member handles are shorter than said base member handles such that all handles function also as alignment components.

13. The cutting device of claim 1 wherein all of said members and components of said device are metal.

14. The cutting device of claim 1 wherein all of said members and components of said device are non-stick coated metal.

15. The cutting device of claim 1 wherein all of said members and components of said device are plastic members and components.

16. The cutting device of claim 1, wherein all of said members and components of said device are metal selected from the group consisting of aluminum and stainless steel.
